(19) United States
(12) Patent Application Publication
(10) Pub. No.: US 2008/0106007 A1
(43) Pub. Date: May 8, 2008

(54) Resin infusion process utilizing a reusable vacuum bag

(76) Inventors: Michael D. Kipp, Highland, UT (US); Dilworth L. Pugh, Mapleton, UT (US); Michael D. Ridges, American Fork, UT (US); William T. McCarvill, Salt Lake City, UT (US)

Correspondence Address: THORPE NORTH & WESTERN, LLP., P.O. Box 1219, SANDY, UT, 84091-1219, US

(21) Appl. No.: 11/975,009

(22) Filed: Oct. 16, 2007

Related U.S. Application Data
(60) Provisional application No. 60/829,831, filed on Oct. 17, 2006.

(51) Int. Cl. B29C 43/12

(52) U.S. Cl. 264/571; 264/226; 425/405.1

(57) ABSTRACT

An improved reusable vacuum bag for use in the manufacture of fiber-reinforced composite components, wherein a polyurea-based prepolymer mixture is applied to a prepared surface, such as the surface of an open mold, and allowed to rapidly polymerize under ambient conditions to form the reusable vacuum bag. The polyurea-based prepolymer is made by combining an isocyanate component with a resin blend component, and preferably mixed and dispensed using a spray device. The prepolymer mixture forms a coating that quickly polymerizes at ambient conditions into a flexible vacuum bag having a shape conforming to the receiving surface. The vacuum bag, once formed, may be used repeatedly to fabricate a plurality of composite parts.

This application claims the benefit of U.S. Provisional Patent Application No. 60/829,831, filed Oct. 17, 2006, and entitled, “Resin Infusion Process Utilizing a Reusable Vacuum Bag,” which is incorporated by reference in its entirety herein.

### FIELD OF THE INVENTION

This invention relates generally to the manufacture of composite parts, and more specifically to reusable vacuum bags which can be used within either of a Vacuum Assist Resin Transfer Mold (VARTM) or resin infusion process, in which resin is drawn into and through a dry fiber preform, as well as a traditional vacuum bagging process, in which air is removed and plies are consolidated during the debulking of a pre-preg structure.

### BACKGROUND OF THE INVENTION AND RELATED ART

Fiber reinforced resin composite articles are fabricated using one of two basic techniques. In a “dry” lay-up process, fiber forms that have been prewetted with resin, forming a “pre-preg” structure, are laid up against a mold to provide the proper shape. The process is “dry” because no new resin is introduced to the fiber forms after the material has been laid up against the mold. In a “wet” lay-up process, a dry fiber reinforcement material, otherwise known as a preform, is laid up on a mold and sprayed, brushed, or otherwise coated or “wet” with the resin. If the resin employed is of the thermoset type, the piece may then cured at an elevated temperature in an autoclave to form the fiber reinforced plastic structure. In other techniques the resin may be designed to polymerize at ambient temperature.

Composite manufacturing methods can be further distinguished by their use of either closed mold or open mold processes. A common manufacturing method using a closed mold process is the resin transfer molding process (hereinafter “RTM”). RTM is a version of the “wet” lay-up process in which a continuous strand mat or fiber preform is positioned on an open female mold or tool. A rigid, cooperatively shaped male mold is mated to the female mold and the sealing edges of the two are pressed together, creating a cavity of fixed dimensions which encloses the fiber preform. A catalyzed resin mix is thereafter pumped into the cavity formed between the two mold surfaces. After a suitable curing cycle, the part is removed from the mold.

Closed mold methods such as RTM offer several advantages and can be cost effective when molding relatively small articles. Because a closed mold is rigid and easily sealed, the resin can be injected under pressure at one end while at the same time employing a vacuum to remove air from the sealed cavity at the other. Removing air before the resin is introduced reduces the possibly of air pockets and resin voids in the composite matrix and results in a stronger finished product. Another advantage of the closed mold is that as a closed system, all emissions of hazardous fumes can easily be controlled. Yet another benefit is the minimal set-up time; the mold can be used again immediately after the resin is cured and the previous part removed. Finally, because both halves of the closed mold provide rigid, smooth surfaces, the final composite product has a quality surface finish on both sides. Unfortunately, because of the high cost of matched metal dies and high tonnage presses, parts produced with closed molds are generally limited in size and geometry.

As a consequence, most large composite articles, such as boat hulls, are currently manufactured using open molds and “wet” lay-up processes. These methods generally involve positioning a mat of fiber reinforcement material in a single open mold cavity and spraying or flow coating the fiber material with liquid curable resin. A variation of this method involves chopping fiberglass in front of the resin spray stream, depositing the curable resin and the fiber reinforcements simultaneously in the open mold. A significant drawback to these “wet” open mold methods of fabrication is the release of large amounts of hazardous air pollutants (hereinafter “HAPs”) into the surrounding atmosphere, which is a matter of great concern both to the Environmental Protection Agency (EPA) and the Occupational Safety and Health Agency (OSHA). A solution for reducing HAPs, which is well known in the art, is to enclose the open mold and the fiber reinforcement material within an impermeable liner or vacuum bag during application of the resin. This method is formally known as Vacuum Assisted Resin Transfer Molding (hereinafter “VARTM”), but is more commonly referred to as an “infusion” process.

In VARTM processing, the dry fiber mat, or ‘preform’, is applied over a mold surface to form a lay-up of fiber reinforcement material of desired thickness. Resin injection ports and vacuum suction ports are installed at selected locations around the preform lay-up, and a flexible, gas impervious sheet, liner, membrane, film, or bag (hereinafter “bag”) is placed over the entire assembly. The edges of the bag are clamped or sealed around the periphery of the mold to form a sealed vacuum envelope surrounding the preform lay-up. A vacuum source is placed in pneumatic or fluid communication with the space between the open mold and the bag and is used to draw a vacuum and to create a negative pressure within the sealed vacuum envelope. Resin is then introduced, or ‘infused’, into the interior of the vacuum bag after negative pressure is applied. Under ideal circumstances, the induced negative pressure serves to shape the article to the mold, to draw the resin through the fiber mat, completely “wet” the fiber, and to remove any air that might cause the formation of voids within the completed article. The negative pressure is maintained while the wetted fiber is pressed and cured against the mold to form the fiber reinforced composite structure or part having the desired shape. Once the composite part is fully cured, the bag is normally removed from the molded article and discarded as waste.

The use of an impermeable bag offers a significant advantage as HAPs generated from resin transfer are greatly reduced. However, it also creates a host of new manufacturing difficulties which, in turn must be overcome. One ongoing concern is the potential formation of air pockets or voids in the composite part that can result in both structural deficiencies and reduced aesthetics. As the bag is normally a thin, flat sheet laid upon the fiber preform, which is in turn laid up against the contoured surface of the open mold, the bag must be carefully folded or cut and taped to conform to the shape of the finished part. Any location where the bag is folded, wrinkled or bunched together creates the potential for a pocket of air, gas, or vapor to form between the bag and the fiber preform. Additionally, wrinkles can also form on the surface of the bag during setup, which allow excess resin to accumulate between the bag and the fiber preform, permanently transferring the impression of the wrinkle to the surface of the completed composite part. Although slowing down the evacuation process can reduce the occurrence of air pockets and wrinkles, it also results in reduced production rates, and therefore increased costs.

Any taped seam in the bag also creates the potential for a pinhole leak, which will cause air to be introduced into the resin stream. This problem causes a quality issue commonly called “bubble trails”. Such defects that are not corrected during the molding process require costly reworking. Moreover, if the bag is of inadequate thickness, the induced negative pressure may draw portions of the bag film down into the intricacies in the fiber preform to partially block the flow of the resin. This phenomenon may require additional flow time to allow the affected area to be filled from another direction, and may also result in a structural defect caused by incomplete wetting of the fiber preform by the resin.

The method of properly installing traditional bags is labor-intensive, especially for very large structures, such as boat hulls. Trained technicians must accurately lay the bag over the contoured surface of the open mold and fiber preform, and attention must be taken when taping and sealing the outer edges of the bag against the sealing surfaces around the periphery of the open mold. Special care is required when installing the resin injection and vacuum suction ports to properly tape and seal the holes in the bag. Furthermore, additional up-front effort must also be spent assembling resin supply and vacuum suction manifolds which connect to the injection and vacuum ports. These piping systems are normally disposable as they become clogged with the resin after each use and must be discarded.

In the typical VARTM process every step in assembling the vacuum bag must be duplicated each time a part is built. It is recognized that it is costly to discard the completed vacuum bag after each use, but as the bag film must be thin and flexible in order to be applied in the first place, it lacks the structural integrity to withstand removal, cleaning and repositioning without tearing. Therefore, the expensive process of manually assembling the vacuum bag by laying down the bag film, attaching the injection and vacuum ports, and sealing the periphery of the bag against the open mold must be repeated for each new composite structure which is to be built using the resin infusion process.

A similar problem exists with the bags used in the traditional vacuum bagging process, which has long been used in industry to fabricate laminated articles comprised of composite materials that are adhesively bonded together. To make a composite or laminated article, a few thin layers of “pre-preg” fiber reinforcement material are stacked upon the forming surface portion of an open mold. A flexible gas impervious vacuum bag, similar to the one discussed above, is then placed over the composite or laminated article. A tacky tape, such as chromium tape, is continuously applied between the bag and the periphery of the open mold. Thus, a volume defined by the bag and the open mold is sealed off.

A vacuum source is placed in pneumatic or fluid communication with the space between the forming tool and the bag and is used to create a negative pressure in the sealed off volume. The creating of the negative pressure performs several functions. First, the bag is firmly pressed against the pre-preg fiber material laid up on the open mold, thereby forming the materials to the shape of open mold. The vacuum also draws out any pockets of air which were left trapped between the plies of pre-preg material, consolidating the layers into a tighter laminate structure. What is left is a few layers of a tight composite, laminate structure which may be further built up to produce a light-weight, high-strength laminated article that is capable of being used as an aircraft component.

When the vacuum induces an internal collapse of the bag against the prepreg fiber reinforcement, the bag has a tendency to restrict the air from freely flowing through the fiber reinforcement, trapping pockets of air and other vapors between the bag and the composite structure. To counteract this problem, a breather layer with a permeable release film may be positioned between the pre-preg lay-up and the inside of bag. The breather layer stops the bag from completely collapsing on the lay-up and allows for all excess air and gas to escape the consolidating structure. For each consolidation/debulking step in the vacuum bag process, a few plies of pre-preg fiber reinforcement are placed on the previous lay-up, a release film is applied over the pre-preg material, followed by the breather layer. The entire assembly is then sealed with the vacuum bag and a vacuum is pulled. The above steps are repeated to produce the finished composite or laminated article having a large number of plies. Sheets of honeycomb core can also be laid upon or between layers of composite material to produce panels of various shapes and sizes. An additional step of heating the composite or laminated article while under pressure in an oven or pressurized autoclave oven can be used to cure the adhesive resins in and between the plies of the laminated materials.

Unfortunately, the vacuum bags that use a plastic sheet and the sealing tape are not robust and durable, and cannot be used to apply more than a few layers of laminates before they are discarded and replaced. Thus, when a given composite or laminated article is produced, a skilled worker must fashion the vacuum bag and then attempt to use it for as many operations as possible. Fabricating a vacuum bag for each article in a production run is time consuming and expensive. Moreover, for parts with many layers a large quantity of used vacuum bags are discarded, adding undesirable solid waste.

Attempts have been made to provide a reusable vacuum bag and to eliminate many of the problems discussed above. One particular technique discussed in the prior art involves applying a viscous silicone rubber compound in multiple coats over the same open mold used to manufacture the composite part. The viscous silicone cannot be applied by spraying, but instead must be poured or brushed onto the open mold. Moreover, the bag cannot be manufactured quickly as each layer of silicone rubber takes time to set before the next layer is applied. Finally, because of its high density and weight a silicone rubber bag does not work well with large open mold tooling like those used to fabricate boat hulls. Such a large bag would be too unwieldy and likely to tear under its own weight if handled improperly.

Another technique involves spraying a silicone-based material over an opposing mold to form a reusable vacuum bag which is soft and flexible yet conforms to the contours of the opposing mold. While a soft and flexible bag may be useful with small parts, some rigidity and stiffness is needed when working with large open molds, as the carefully-positioned layer of fiber preform will be displaced or damaged if the vacuum bag is dragged over the top. Moreover, the silicone-based vacuum bag takes considerable time to form, as the silicone must react with moisture in the air in order to completely polymerize, which process can take hours or days. For all these reasons, what is needed is a reusable vacuum bag for use in the composite manufacturing process which can be manufactured quickly and inexpensively, and yet is lightweight and rigid enough to be maneuvered around large open molds without disturbing the prepared fiber preforms.

### SUMMARY OF THE INVENTION

In light of the problems and deficiencies inherent in the prior art, the present invention seeks to overcome these shortcomings by providing a reusable vacuum bag forming system which can be quickly and inexpensively used to fabricate a vacuum bag which fits the custom contours of an open mold. The low cost of making the vacuum bag allows it to be economical even if used only once, and yet it is sufficiently robust and durable to be reused many times. The bag forming system meets or surpasses current regulatory requirements by providing a sealing barrier which prevents the inadvertent release of hazardous air pollutants created in the composite manufacturing process into the surrounding environment.

In accordance with the invention as embodied and broadly described herein, the present invention features a method for forming a reusable vacuum bag for use in the manufacture of a composite part, the method comprising: (a) applying a prepolymer mixture configured for rapid polymerization at ambient temperature over a surface having a configuration corresponding to the composite part; (b) rapidly polymerizing the prepolymer mixture to form a vacuum bag having a periphery and a shape substantially conforming to the surface; and (c) removing the vacuum bag from the surface.

The present invention also features a method for making a reusable vacuum bag for use in a resin infusion process for the manufacture of a composite part, the method comprising: (a) obtaining an isocyanate component comprising an isocyanate building block connected to a flexible link with a urethane bond; (b) obtaining a resin blend component comprising an amine-terminated polymer resin; (c) mixing the isocyanate component with the resin blend component to obtain a polyurea prepolymer mixture, the polyurea prepolymer mixture being configured for rapid polymerization at ambient temperatures; (d) applying the polyurea prepolymer mixture in liquid form over a surface; (e) rapidly polymerizing the polyurea prepolymer mixture to form a reusable vacuum bag having a periphery and a shape substantially conforming to the surface; and (f) removing the vacuum bag from the surface.

The present invention further features a method for vacuum impregnation of a reinforcing fiber material using a resin infusion process to produce a resin-fiber composite part, the method comprising: (a) obtaining a polyurea prepolymer mixture in liquid form; (b) causing the polyurea prepolymer mixture to rapidly polymerize by applying the polyurea prepolymer mixture over a surface to form a reusable vacuum bag having a periphery and a structure substantially conforming to the surface; (c) removing the vacuum bag from the surface; (d) positioning at least one layer of a reinforcing fiber material onto an open mold; (e) positioning the vacuum bag over the at least one layer of reinforcing fiber material and sealing the periphery to form an airtight chamber encapsulating the reinforcing fiber material between the open mold and the vacuum bag; (f) injecting a resin into the airtight chamber; and (g) applying vacuum pressure to the airtight chamber to draw resin through the reinforcing fiber material.

The present invention still further features a method for vacuum impregnation of a reinforcing fiber material using a vacuum bagging process to produce composite part, the comprising: (a) obtaining a polyurea prepolymer mixture in liquid form; (b) causing the polyurea prepolymer mixture to rapidly polymerize by applying the polyurea prepolymer mixture to a surface at ambient conditions to form a reusable vacuum bag having a periphery and a structure substantially conforming to the surface; (c) removing the vacuum bag from the surface; (d) positioning at least one layer of fiber reinforcement pre-pregs onto an open mold; (e) positioning the vacuum bag over the at least one layer of fiber reinforcement pre-pregs and sealing the periphery to form an airtight chamber encapsulating the fiber reinforcement pre-pregs between the open mold and the vacuum bag; and (f) applying vacuum pressure to the airtight chamber to withdraw excess air and excess resin from the fiber reinforcement pre-pregs.

The present invention still further features a reusable vacuum bag for use with a composite mold to manufacture a composite part having an upper surface and a lower surface, comprising a layer of polyurea-based polymer having an inner surface, an outer surface, and a periphery, wherein the inner surface if formed to substantially conform to the upper surface of the composite part, and wherein the periphery extends beyond the edges of the composite part to seal the vacuum bag to the open mold.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a perspective view of an exemplary embodiment of an improved vacuum bag forming system for the manufacture of composite parts, wherein a reusable vacuum bag is formed by spraying a prepolymer mixture onto an open mold;

FIG. 2 illustrates a perspective, cut-away view of the embodiment of FIG. 1, in which additional optional components have been added to structure of the reusable vacuum bag;

FIG. 3 is a flow chart describing the method of the reusable vacuum bag forming system of the present invention;

FIG. 4 illustrates a side view of a preferred embodiment of the present invention, wherein the prepolymer mixture is sprayed on an open mold containing a spacer part to form a reusable vacuum bag having the shape of the finished composite part lying in an open mold;

FIG. 5 illustrates a perspective, cut-away view of a preferred embodiment of the vacuum bag forming system applied in the VARTM process, wherein the reusable vacuum bag is positioned over a lay-up of fiber preform on an open mold;

FIG. 6 illustrates a side view of the embodiment of FIG. 5, in which the VARTM process is used in conjunction with the reusable vacuum bag to form a composite article.

FIG. 7 is a flow chart describing a method of the reusable vacuum bag forming system of the present invention as applied in the VARTM process;

FIG. 8 illustrates an exploded side view of a preferred embodiment of the present invention applied in the vacuum bagging process, wherein the reusable vacuum bag is positioned over a lay-up of pre-preg material, peel ply, release film and a breather layer on a open mold; and

FIG. 9 is a flow chart describing a method of the reusable vacuum bag forming system of the present invention as applied in the vacuum bagging process.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

The present invention describes a reusable vacuum bag forming system which can be applied to both the resin infusion and traditional vacuum bagging processes. In accordance with the present invention, the reusable vacuum bag is formed by applying or disposing a polyurea-based prepolymer mixture, made by combining an isocyanate component with a resin blend component, over a contoured surface, such as provided by an open mold or existing component part. The prepolymer mixture forms a coating that rapidly polymerizes at ambient conditions into a flexible, reusable vacuum bag having a shape conforming to the contoured surface, say as the open mold. Once formed, the vacuum bag may be removed and used thereinafter as a reusable top-sealing layer to cover a lay-up of fiber reinforcement material which has been placed on an open mold. The open mold and the bag together create an airtight volume that surrounds the fiber reinforcement material and permits the drawing of a vacuum, a critical step in both resin infusion and vacuum bagging processes.

The term “rapid polymerization,” as used herein, shall be understood to mean the polymerization of the prepolymer within a relatively short time period, preferably less than five minutes. In some embodiments, polymerization may occur within seconds (e.g., one to thirty seconds) after being mixed and applied, while in other embodiments, polymerization may take place in minutes (e.g., between one and fifteen minutes, and preferably less than three-five minutes).

Generally speaking, a composite material, either a dry fiber preform or a pre-wetted pre-preg, may be laid up on the open mold. After the lay-up is complete, the pre-formed, contoured vacuum bag is situated or disposed over the composite material lay up/open mold assembly and sealed around its periphery, forming a gas-tight chamber around the composite material which substantially, corresponds to the shape of the lay-up on the open mold. Vacuum suction lines or resin injection lines are attached to the various ports in the vacuum bag and the fabrication of the composite continued after which the lines are detached and the vacuum bag is removed. The vacuum bag is preferably robust and durable enough to be repeatedly used for an extended number of vacuum process cycles, thus eliminating many problems inherent in prior related vacuum bags and their associated manufacturing processes.

Preparation of the Open Mold for Forming a Present Invention Reusable Vacuum bag can involve a number of specific steps, depending upon the type of composite manufacturing process employed, the size of the intended part and the open mold, and the unique requirements for fabricating a custom composite article. The method of the present invention allows for all these variables. In most circumstances the open mold may be prepared by cleaning the surface and positioning any vacuum suction ports. A release layer may be applied to the open mold before application of the prepolymer mixture to ensure that the vacuum bag readily releases from the open mold after polymerization without tearing or ripping of the bag material, thus maintaining the structural integrity of the vacuum bag. The suction port(s) may be placed on top of the release layer to become encased by the polymerized polyurea material as it is applied, so that the ports pull away along with the bag when it is removed. In a similar fashion, other components may be placed on the open mold, which components may then become integrally bonded to the formed vacuum bag. These components include, but are not limited to, resin injection ports, reinforcement members (e.g., fiber reinforcements), and various attachment connections to be used in lifting and positioned the vacuum bag after formation.

In situations where a finished composite article is to have a uniform thickness throughout, or where the thickness dimension is small when compared to the size of the mold, a vacuum bag which has been built up directly from the open mold will provide a tight fit over the dry fiber preform or a pre-wetted pre-preg lay-up. However, if the finished composite article is to have a variable thickness or if its thickness is significant relative to the size of the mold, a spacer part simulating the dimensions of the finished composite article may be positioned on the open mold before application of the release layer. After the prepolymer mixture has been sprayed, the vacuum bag will then acquire a shape substantially conforming to the finished composite article on the contoured surface of the open mold.

One method for making contoured vacuum bags which follow the surface shape of a complex composite part is to simply spray the bag over a previously completed composite part which is lying in the open mold. This technique results in a custom fit vacuum bag which exactly matches the shape of the composite article lying in the open mold, in essence simulating the upper half of the tooling traditionally used in a closed mold process. The vacuum bag is flexible rather than rigid and can be formed and used to significantly reduce part manufacturing costs, and is highly effective in a VARTM processes as it is similarly reusable and results in a composite part with a high quality upper surface finish.

The bag of the improved vacuum bag forming system overcomes the limitations currently existing in the art as it is easily applied manually or with a spray device, sets up, cures or polymerizes within seconds, and the polymer-based material which makes up the bag has a much higher strength to weight ratio, allowing a far thinner and lighter polymer layer to hold the same vacuum as the bags described in the prior art. Moreover, these same characteristics allow the bag to be used to make very large composite structures, such as boat hulls, as it is lightweight and rigid enough to be maneuvered around large open molds without disturbing the prepared fiber preforms.

The method of the present invention also simplifies the process of creating and assembling a new bag by including the integration of resin injection ports, vacuum suction ports, reinforcements, and flow channels within the structure of the bag itself. Yet another advantage is that the system is highly adaptable and can be applied to open molds having a wide variety of sizes and shapes, such as the large molds used in a resin infusion VARTM process and variations thereof, as well as much smaller molds used in traditional vacuum bagging processes to manufacture or fabricate composite, laminate structures. Moreover, the system naturally eliminates folds and wrinkles often common with vacuum bag films and greatly improves the surface finish of the completed part, while at the same time seriously reducing the probability of leaks forming at seams in the bag film. Still further, the system provides for a vacuum bag that reduces the amount of solid waste generated during the manufacture of composite components by eliminating the need to discard used bags during the manufacture of one or more composite parts.

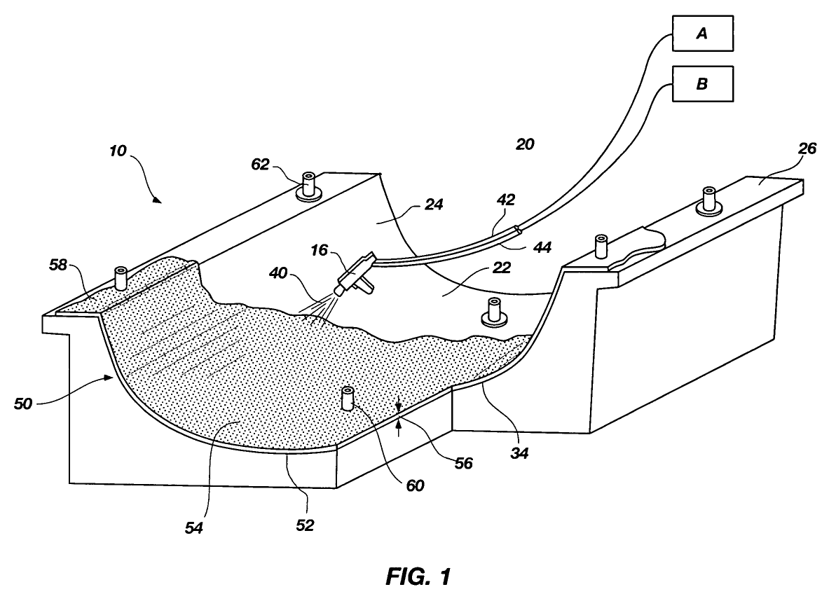

With reference now to FIG. 1, illustrated is a vacuum bag forming system for forming a reusable vacuum bag for use within a resin infusion process in accordance with one exemplary embodiment of the present invention. As shown, a vacuum bag forming system 10 comprises a prepolymer mixture 40, in liquid form, applied to a bag forming structure, which is represented in FIG. 1 by an open mold 20. The prepolymer mixture forms a coating that rapidly polymerizes, namely in a matter of seconds, at ambient conditions, into a semi-rigid vacuum bag 50 having a shape conforming to the contoured surface 24 of the open mold. The bag has an inner surface 52, an outer surface 54, and a thickness 56 which may be further defined as the average distance between the inner and outer surfaces. The bag also may be formed to comprise a periphery 58 that is designed to at least partially cover the sealing surface 26 of the open mold. For the purposes of the present disclosure, ambient conditions are defined as non-elevated temperatures namely between 60° and 80° F., and non-elevated pressures namely atmospheric.

The prepolymer mixture may be made from any component or group of components which combine to form a coating that rapidly polymerizes about a surface to which it is applied into a semi-rigid layer (preferably within seconds) and at ambient conditions. In one exemplary embodiment, the prepolymer mixture comprises a polyurea-based resin made by combining an isocyanate component (that is shown as being communicated through a flow tube 42) with a resin blend component (that is shown as being communicated through a flow tube 44), wherein these two components may be mixed in a spray device 16 and dispensed therefrom. The isocyanate component may be further broken down into an isocyanate building block, such as an MDI monomer, connected to a flexible link with a urethane bond. In the preferred embodiment above, the isocyanate building block may have reactive endgroups selected from a group consisting of polyol or amine, and the flexible link can be selected from a group consisting of polyether, silicone, polybutadiene or other low ‘Tg’ segments.

The present invention vacuum bag comprises a fast setting, fast curing (rapid polymerizing) sprayable prepolymer composition. For example, the sprayable composition may comprise a polyurea-based prepolymer mixture, made by combining an isocyanate component with a resin blend component, such as a polymeric MDI component with a polymeric polyol, or an aromatic isocyanate component with an aromatic polyurea component. An example of some particular types of polymers that may be used and that are well suited for the applications intended herein are discussed below.

To enable rapid polymerization, the isocyanate component, or “A side,” is mixed with a resin blend, or “B side” component, which in one embodiment, as discussed above, comprises an amine-terminated polymer resin. When mixed together, the two A and B side components combine by way of a urea bond to form a long, polyurea-based molecule, which then cross-links with other similar molecules to form the semi-rigid, reusable polymer vacuum bag of the present invention.

The sprayable prepolymer composition may also comprise a silicone-modified polyurea composition.

The polyurea-based prepolymer mixture forms a coating that rapidly polymerizes at ambient conditions into a flexible, substantially non-porous seal having a shape conforming to the surface to which it is applied.

As indicated, the present invention contemplates many different types or variations of the prepolymer composition. For purposes of discussion, an exemplary first specific type of polyurea-based prepolymer composition comprises a two part polyurea, namely an “A” side polymeric MDI comprised of diphenylmethane-diisocyanate (MDI), and modified MDI; and a “B” side polymeric polyol comprised of aliphatic amines (polyoxypropylene diamine), di-ethyl toluene diamine (DETDA). The “A” side is present in an amount by weight between 25 and 40 percent, and preferably between 30 and 35 percent. The “B” side is present in an amount by weight between 60 and 75 percent, and preferably between 65 and 70 percent. This composition is available under the several products being marketed as Reactamine®, or as comprising Reactamine® technology.

An exemplary second specific type of polyurea-based prepolymer composition comprises a two part polyurea, namely an “A” side aromatic isocyanate comprised of polyurethane prepolymer, diphenylmethane-diisocyanate (MDI), and alkylene carbonate; and a “B” side aromatic polyurea comprised of polyoxyalkyleneamine, diethyltoluenediamine (DETDA), and polyoxyalkyleneamine carbon black. The “A” side is present in an amount by weight between 40 and 60 percent, and preferably between 45 and 55 percent. The “B” side is present in an amount by weight between 40 and 60 percent, and preferably between 45 and 55 percent. This composition is available from Bay Systems North America.

It is noted that these two compositions are not meant to be limiting in any way. Indeed, those skilled in the art may realize other compositions that may be used to provide a multi-function vacuum bag as taught and described herein.

The polyurea-based polymer provides significant improvements over prior vacuum bags. The polymer is rigid enough to maintain the shape of the open mold even after removal, yet flexible enough to bend with movement and to provide an airtight seal when placed against the sealing surface of the open mold. Furthermore, the polymer is durable and tough enough to withstand repeated mechanical abuse experienced in the manufacturing process. Although not the focus herein, the bag may be configured to withstand or endure part curing cycles in an autoclave or oven at known elevated temperatures for extended periods of time. One additional advantage over traditional or existing vacuum bags is that the polyurea-based material may be formulated to be naturally translucent, enabling operators to view and monitor the resin front as it advances through the assembly, and to verify that all portions of the fiber preform have been wetted with resin.

The open mold or tool illustrated in FIG. 1 has a mold cavity 22 forming a concave configuration, but the method of making the vacuum bag according to the present invention is not limited to such a configuration. The prepolymer mixture 40 works equally well with molds or tools having a flat or convex configuration, as well as various combinations of these. The prepolymer mixture 40 may also be applied over surfaces having various protrusions or peaks, valleys or recesses, and combinations of these. In other words, the prepolymer mixture may be applied over any part forming structure having a surface having any contour due to the rapid polymerization of the prepolymer mixture to take on a solidified form shortly after being applied to the surface.

While not a requirement, the contoured surface 24 and sealing surfaces 26 of the mold may be prepared before applying the prepolymer mixture onto the tooling. This preparation may consist of simply applying a release layer 34 to ensure that the vacuum bag readily releases from the open mold after polymerization without tearing or ripping the bag material, therefore maintaining the structural integrity of the vacuum bag.

In another exemplary embodiment, at least one vacuum suction port 62 or other structural member may be positioned on top of the release layer to become encased within the polymerizing polyurea material as it is applied, so that the port (or other structure) becomes an integral part of the vacuum bag 50 once formed, and removed from the mold cavity 22. Integrating the vacuum port or ports into the body of the vacuum bag provides significant advantages over the prior art. Following existing practices, vacuum ports are normally added after the impervious sheet has been laid down over the fiber reinforcement preforms or pre-pregs. This requires the technicians to make a hole in the sheet, install the port, and then seal up the sheet around the port. The process is not only labor intensive, but cutting and sealing the impervious liner always creates the potential for an air leak when drawing the vacuum. By integrating the vacuum ports into the bag during the spraying process, a tight seal is made certain and several previous steps in existing bag forming practices are eliminated.

It is well known that only one or two vacuum suction ports are required during the vacuum bagging process, but both vacuum suction ports 62 and resin injection ports 60 are needed in the resin infusion process, usually several of each. Placement of the two types of ports varies widely according to the size and shape of the composite part to be fabricated and the expertise of the manufacture. Placement of the ports to control the flow resin through the fiber preform is as much of an art as a science, and such placement is not in any way limited to the locations depicted in the attached figures, which were selected only for illustrative purposes. The method of the present invention allows for all these variables. The resin injection ports and vacuum suction ports may be placed at any location or any number of locations, each of which may be intended to become encased within the polymerizing prepolymer mixture as it is applied, and to become an integral part of the vacuum bag once formed and removed from the mold cavity.

According to the preferred embodiment shown in FIG. 1, after polymerization is complete the vacuum bag can be removed from the open mold and later used in a resin infusion process for the fabrication of fiber-reinforced composite articles or parts. As polymerization takes place in a matter of seconds, the lengthiest process in forming the vacuum bag is that required to prepare the open mold by applying the release layer and locating or positioning the resin injection ports and vacuum suction ports. The bag is ready for removal and use within seconds after the spraying is completed. Consequently, and according to the method of the present invention, the time to form a vacuum bag and to fabricate a composite part using a resin infusion process is significantly reduced compared with prior related resin infusion processes and the components utilized therein.

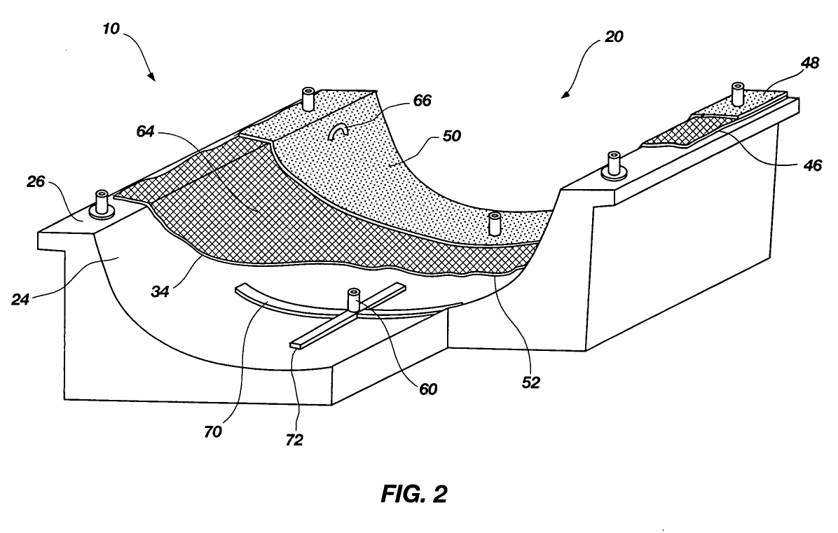

FIG. 2. is a perspective, cut-away view of an exemplary embodiment similar to that of FIG. 1, wherein a vacuum bag forming system 10 is used to form a reusable vacuum bag in accordance with the present invention. Unlike that shown in FIG. 1, however, the vacuum bag forming system comprises one or more components to be integrated into the structure of the formed vacuum bag 50. As discussed above, such components may comprise resin injection ports, vacuum ports, reinforcement fibers or other members, and any others known in the art. Besides the integration of resin injection ports and vacuum suction ports into the body of the vacuum bag, as discussed, it may also be desirable to add reinforcement members, such as reinforcement fibers 64, to certain sections of the vacuum bag to increase its stiffness and/or strength. This is especially important when the open mold 20 is large and the bag is configured to cover a large surface area, and where it is still desirable to move the bag as a single, unitary piece.

To add reinforcement fibers 64 to the vacuum bag, a first layer of prepolymer mixture 46 may be applied onto the contoured surface 24 of the open mold (preferably by spraying), including the future sealing surfaces 26. The reinforcement fibers 64 may then be placed on the first layer of the prepolymer mixture, either during or after the polymerization phase of the first layer. A second layer of prepolymer mixture 48 may then be applied over the first, bonding with the first layer and completely encasing the reinforcement fibers 64. Attachment devices, such as rings or hooks 66 may also be integrated into the vacuum bag to facilitate lifting and moving the bag during manufacturing operations.

According to the present invention, additional layers of reinforcement fiber and prepolymer mixture may also be applied to various locations as needed, building up the vacuum bag to be stronger and stiffer in some areas and while leaving other sections to be softer and more flexible. This enables the user to create a vacuum bag which is more stiff and rigid over the fiber preform to control the shape and finish of the completed composite part, but also one that is softer and more flexible around the periphery to facilitate a better seal. A vacuum bag of this nature functions in a similar manner as the upper cooperatively-shaped rigid male mold used in conventional RTM processes previously described. However, the present invention vacuum bag can be built far quicker and at significantly less expense than the rigid metal dies often used, and can be applied to much larger tooling.

FIG. 2 also illustrates the use of a spacer 70 designed to impart a form, shape, or groove in the inner surface 52 of the vacuum bag 50. Unlike the various resin injection or vacuum ports, reinforcement fibers or attachment devices which are permanently integrated into the structure of the bag, the spacer material remains separate from the formed vacuum bag, and simply functions as an additional surface over which the prepolymer mixture is applied. This functions to form contour or shape within the vacuum bag that corresponds to the spacer 70. This is accomplished by positioning the spacer on the surface of the open mold before any release layer 34 is applied. The inner surface of the vacuum bag will permanently retain the impression of the spacer. Simply for illustrative purposes, and as shown, a long, narrow spacer 72 may be used to form the imprint of a resin flow channel leading away from a resin injection port 60. Other spacers of different configurations, such as different thicknesses, sizes and shapes, may be used to control both the flow of resin underneath the vacuum bag as well as direct the air flow during the vacuum suction process. Still further, a spacer may be formed and configured to create spaces for additional layers of fiber preform, which in turn allows the composite part manufacturer to create complex articles with better mechanical characteristics.

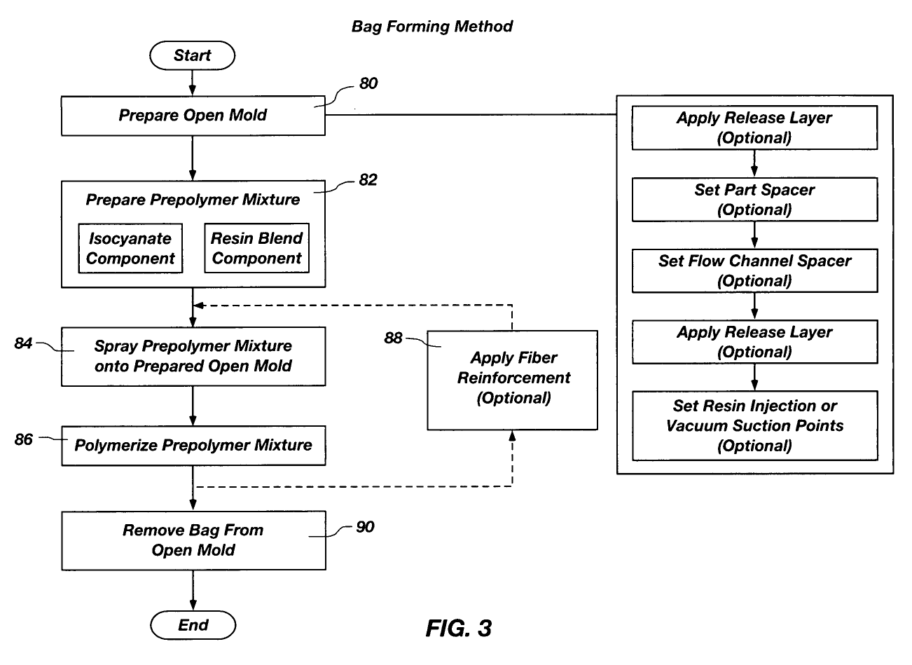

FIG. 3 illustrates a flow diagram describing an exemplary method for forming a reusable vacuum bag for use within a resin infusion process in accordance with the present invention. Specifically, FIG. 3 illustrates a flow diagram of the various elements discussed above. As shown, the method comprises step 80, preparing an open mold to receive the prepolymer mixture, which optionally may include, and is not limited to, applying a release layer to facilitate removal of the vacuum bag after polymerization, setting or positioning one or more spacer components, positioning one or more vacuum suction or resin injection ports, etc; step 82, preparing a prepolymer mixture, such as mixing an isocyanate component with a resin blend component, respectively; step 84, applying the prepolymer mixture to the prepared surface of the open mold; step 86, allowing the prepolymer mixture to polymerize to form a vacuum bag having a surface shape that corresponds to that of the open mold and any components positioned thereon; and step 90, removing the formed vacuum bag from the open mold. FIG. 3 further illustrates step 88, applying one or more fiber reinforcement members to the open mold at select locations prior to applying the prepolymer mixture.

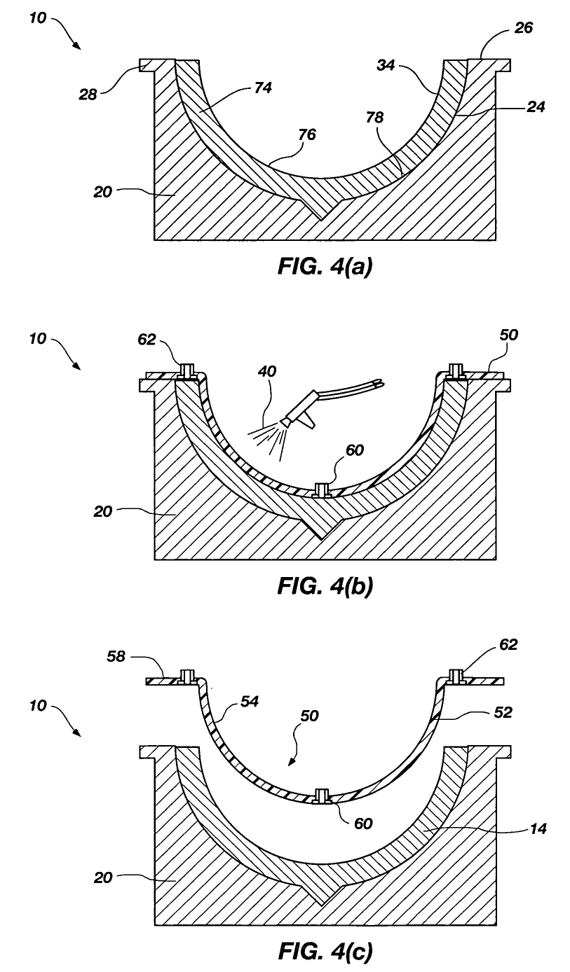

Yet another aspect of using a spacer of some sort may be to modify the overall shape of the vacuum bag with respect to the open mold. For instance, it may be desirable to create a vacuum bag that is slightly smaller in scale than surface of the open mold in which a composite part is to be formed. This situation is illustrated in FIGS. 4(a)-4(c). As shown, the vacuum bag 50, having an inner surface 52 and an outer surface 54, is formed by applying the prepolymer mixture 40 to a spacer part 74 previously situated within the open mold 20, wherein the spacer part comprises an outer or top surface 76 that corresponds to a top surface of a finished composite part, a bottom surface 78 which corresponds with a bottom surface of a finished composite part and which mates with the contoured surface of the open mold 24, a thickness, and an overall configuration designed to correspond to that of the composite part or a layer to be formed. More specifically, the spacer part may be used to provide a vacuum bag having a contour that corresponds to the upper surface of a composite part to be fabricated, thus providing a more accurate fit during the manufacture of the composite part. The spacer part is intended to perform multiple functions, such as to account for a thickness of the composite part, and to facilitate formation of a vacuum bag that will better fit the lay-up over the open mold. This procedure may be followed when the size or shape of the finished composite article relative to the size of the open mold will not allow a vacuum bag which has been formed directly from the contoured surface of the open mold to properly fit the top surface of the fiber preform disposed about the open mold.

As illustrated in FIG. 4(a), the thickness of a finished composite article, or one of its intermediate layers, may be such that a vacuum bag formed directly from the contoured surface of an open mold would not fit properly over the fiber preform. For instance, the vacuum bag may not match the contours of the fiber preform or properly seat and seal against the sealing surfaces 26 of the open mold.

Likewise, the open mold may be configured to form a finished composite article having a non-uniform thickness, including projections, such as the keel section on a composite boat hull. As indicated, to account for such variations in thickness, as well as to form a vacuum bag having a contour that conforms to an upper surface of a composite part or fiber preform, a spacer part 74, which mimics the structure of the finished composite article, is first placed in the open mold 20 as shown in FIG. 4(b). Any additional spacer components are then positioned before application of any release layer 34, after which any resin injection ports 60, vacuum suction ports 62, as well as any attachment devices and reinforcements (not shown) that are to be integrated with the prepolymer mixture 40 as described above to form a vacuum bag are then positioned. Once these are in place, the prepolymer mixture may be applied to the spacer part which mimics the fiber preform over which the formed vacuum bag will ultimately be placed. The prepolymer mixture, upon polymerization, functions to conform to the top surface 76 of the spacer part, thus creating a vacuum bag having a slightly smaller scaled inner surface 52 as compared to the contoured surface 24 of the open mold. As so formed, the finished vacuum bag may then better conform to the fiber preform 14 used to create the finished composite article, which preform, as stated, is similar in size and shape as the spacer part used to create the vacuum bag. As illustrated in FIG. 4(c), the formed vacuum bag 50 may be placed over the fiber preform in preparation for and prior to initiation of a resin infusion process.

Alternatively, an existing composite article may be used as the forming surface for creation of the vacuum bag in place of a dedicated spacer part. For example, a first finished composite article may be made using standard bag forming techniques, after which it may serve as the surface for the formation or creation of a reusable vacuum bag made according to the present invention. All finished composite articles thereafter may be fabricated using the formed reusable vacuum bag.

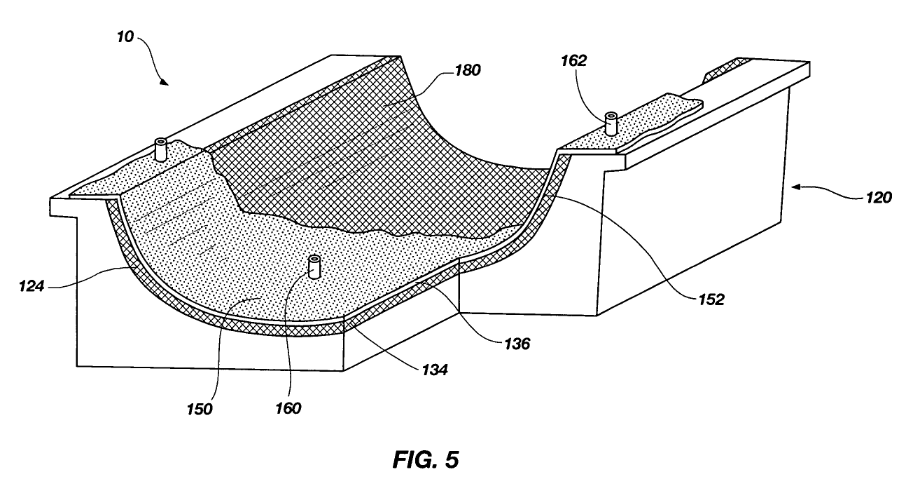

With reference to FIG. 5, illustrated is a perspective, cut-away view of resin infusion system according to one exemplary embodiment of the present invention. As shown, the resin infusion system 110 utilizes a reusable vacuum bag 150 formed in accordance with any one of the methods described above, wherein the reusable vacuum bag 150 is first formed in the open mold 120 and may integrate one or more resin injection ports 160 or vacuum suction ports 162, as well as any attachment devices and reinforcements (not shown). After the vacuum bag has been removed, a first release layer 134 may then be applied to the contoured surface 124 of the open mold. This first release layer may be any coating or film which will allow the finished composite article to readily release from the mold tool as commonly known. The release layer is then followed by a lay-up of reinforcement material to create a fiber preform 180 which defines the form and shape of the finished composite part. The fiber preform may be assembled from any number of materials well known in the art and which may further assume a variety of configurations, from continuous fiber mats to interlocking segments to sprayed-on fibers and the like, including the use of multiple layers, all which are also well known in the art. The fiber preform 180 as described above is also inclusive of any inserts or foreign material which may be added to the reinforcement material to affect the physical properties of the finished composite part.

The inner surface 152 of the reusable vacuum bag is normally configured and intended to impart a smooth, quality finish to the completed composite article. However, it may be desirable to alter the finish of the upper surface in some way, in which case a second release layer 136 or film may be optionally applied to the top surface of the fiber preform. A second release layer, such as a Teflon coating, may also be applied directly to the inner surface of the reusable vacuum bag to improve the release of the bag after the vacuum processing step has been completed.

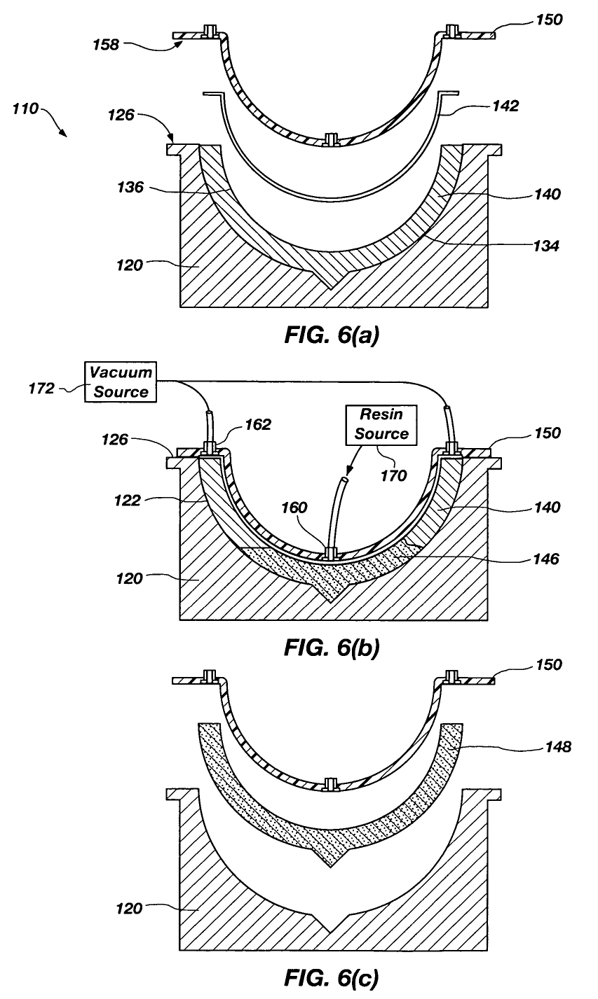

Referring now to FIG. 6(a), a release layer 134 is placed on the open mold 120, after which a lay-up of fiber preform 140 is put into position. A second release layer 136 may then be applied to the top surface of the fiber preform. Furthermore, a layer of distribution media 142 may optionally be placed over the fiber preform. The distribution media can be useful in helping the resin to “sheet out” over the surface of the preform, from which it can then be drawn down into the fiber matrix of the preform either by vacuum, gravity, or capillary action.

At this point the reusable vacuum bag 150 is placed over the lay-up of fiber preform and with reference to FIG. 6(b), the periphery 158 of the bag is clamped or sealed against the sealing surfaces 126 of the mold to form a sealed vacuum envelope surrounding the preform lay-up. An air-tight seal between the vacuum bag and the open mold can be formed by any of method well-known in the art, including the application of liquid adhesive or tacky tape such as chromium tape continuously around the periphery of the open mold.

A vacuum source 172 is placed in pneumatic or fluid communication with the sealed volume between the mold cavity 122 and the vacuum bag 150 via vacuum suction ports 162 and is used to draw a vacuum in the sealed vacuum envelope. Resin 146 in liquid form from a resin source 170 is introduced, or ‘infused’, into the interior of the vacuum through resin injection ports 160. Under ideal circumstances, the vacuum serves to shape the article to the mold, to draw the resin through the fiber preform 140, to completely “wet” the fiber, and to remove any air that would form voids within the completed article. The vacuum is maintained while the wetted fiber preform is pressed against the mold and cured to form the finished composite article 148 with the desired shape. Such resin infusion processes are well known in the art. However, the present invention contemplates a modified resin infusion process utilizing the reusable vacuum bag discussed herein.

After curing, the vacuum bag 150 may detached from the finished composite article in one piece without ripping, tearing or any damage other than slight wear for the usage, as shown in FIG. 6(c). The bag may be used again once the finished composite article 148 is removed and a new lay-up of fiber preform installed in its place. A reusable bag that can be repeatedly used to create a plurality of like composite parts is advantageous in that there is no need to expend additional effort preparing a disposable vacuum bag over the new fiber preform, which process often takes more time than laying up the fiber preform itself. Indeed, the reusable vacuum bag of the present invention is robust and durable enough to be repeatedly used for an extended number of vacuum process cycles. At any point during the life cycle of the reusable vacuum bag the open mold can be prepared and a replacement or supplemental bag made quickly and easily.

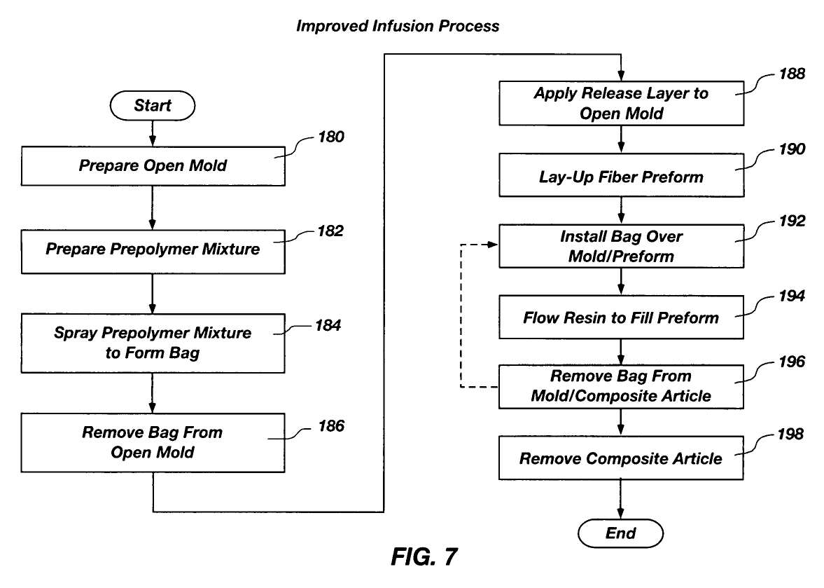

FIG. 7 illustrates a flow diagram depicting an exemplary resin infusion process for forming a composite part utilizing the reusable vacuum bag of the present invention. Specifically, FIG. 7 illustrates a flow diagram of the various elements discussed above. As shown, the method comprises step 180, preparing an open mold to receive the prepolymer mixture, which optionally may include, and is not limited to, applying a release layer to facilitate removal of the vacuum bag after polymerization, setting or positioning one or more spacer components, positioning one or more vacuum suction or resin injection ports, etc; step 182, preparing a prepolymer mixture, such as mixing an isocyanate component with a resin blend component, respectively; step 184, forming the bag by applying the prepolymer mixture to the prepared surface of the open mold and allowing the mixture to polymerize to form a vacuum bag having a surface shape that corresponds to that of the open mold and any components positioned thereon; and step 186, removing the formed vacuum bag from the open mold.

The method continues with step 188, applying a release layer to the open mold; step 190, laying up a fiber preform onto the contoured surface of the open mold, which optionally may include, and is not limited to applying a second release layer over the fiber preform followed by an optional sheet of distribution media; step 192, installing a bag previously formed using steps 180 through 186 over the open mold and fiber preform, sealing the bag around the periphery of the open mold to form an airtight envelope, and placing the sealed volume in fluid communication with both a vacuum source and a resin source by connecting the respective ports to the appropriate systems; step 194, flowing the resin into and through the fiber preform by drawing a negative pressure to remove entrapped air or gases and introducing the liquid resin into the sealed volume and allowing it flow throughout and completely wet the fiber preform and maintaining the negative pressure until the resin has cured; step 196, removing the bag from the open mold and the finished composite article and reusing it again in step 192; and step 198, removing the finished composite article from the open mold.

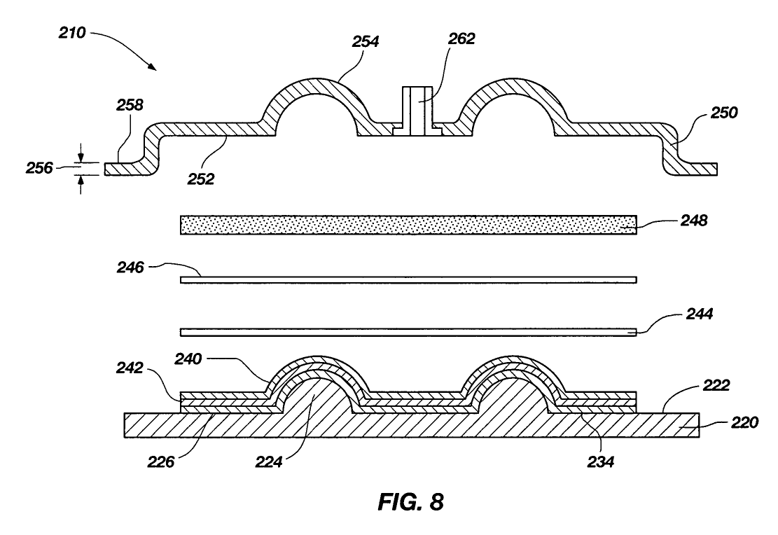

FIG. 8 illustrates an exploded side view of a vacuum bagging system 210. In accordance with the present invention, a reusable vacuum bag 250 is first formed on the open mold 220 using any one of the methods described herein, or obvious variants thereof. As illustrated in FIG. 8, the open mold has an upper surface 222 with a sealing portion 226. The upper surface may also include contoured shapes 224 which may be protrusions (as shown in FIG. 8) or depressions, or any combination of the above as needed to form a composite part with the desired dimensions.

After the vacuum bag has been removed, a first release layer 234 may be applied to the contoured surface 124 of the open mold. The release layer may be any coating or film known in the art which will allow the finished composite article to readily release from the mold tool after curing. The release layer is followed by a lay-up of pre-wetted fiber reinforcement material, or pre-pregs. The pre-preg may be laid up in a single thick layer, but more commonly a small number of thin pre-preg plies 242 will be laid one on top the other to form a first portion of the composite article known as the laminate 240.

The next three processing layers shown are completed in accordance with standard steps that are well known in the art. An optional peel-ply 244 may be laid over the pre-preg plies to give the laminate a bondable finish to better adhere to the next sequence of pre-preg plies. The peel ply is in turn covered by a permeable release film 246 which is configured to not bond to the laminate, and to allow air to pass through to the next layer above, which may be a breather layer 248 that provides a continuous air path between the laminate and the vacuum bag for the pulling the vacuum during consolidation and debulking.

The complete lay-up comprising the laminate, peel-ply, release film and breather layer is then covered by the reusable vacuum bag 250. The periphery of the bag 258 is clamped or sealed against the sealing surfaces 226 of the mold to form a sealed vacuum envelope surrounding the lay-up. An airtight seal between the vacuum bag and the open mold can be formed by any method well-known in the art, including the use of tacky tape such as chromium tape installed continuously around the periphery of the open mold.

A vacuum source (not shown) is placed in pneumatic or fluid communication with the volume between the mold tool and the vacuum bag via the vacuum suction port 262. the vacuum source functions to create a negative pressure or vacuum environment within the sealed off volume. The drawing of the vacuum performs several functions. First, the vacuum bag 250 is firmly pressed against the pre-preg laminate 240 laid up on the open mold 220, thereby forming the materials to the shape of open mold. The vacuum also draws out any pockets of air which were left trapped between the layers of pre-preg material, consolidating the layers into a tighter laminate structure. After the consolidation/debulking step is completed, the vacuum bag 250 is removed along with the three processing layers. A new group of pre-preg plies are laid up over the old laminate structure, and the process is repeated until the laminate composite part has been built up into its intended size. After the final group of pre-preg plies has been consolidated and debulked onto the layers beneath, the entire laminate assembly, including the vacuum bag, may be placed in an autoclave where a vacuum is continuously pulled while the composite part is heated to curing temperature. After curing and removal from the autoclave, the vacuum bag 250 may detach from the finished composite article in one piece without ripping, tearing or any damage other than slight wear for the usage. From this, it can be seen that the reusable vacuum bag may also be intended for use within an elevated temperature environment, such as an autoclave or oven, where temperatures can range between 100° and 500° F. or more.

One key advantage the present invention over the prior art is that the vacuum bag is robust and durable enough to be reused for a high number of consolidation/debulking vacuum cycles, as well as to withstand the elevated temperatures that it may be subject to during the curing cycle in an autoclave. In contrast, current vacuum bags employ a plastic sheet which cannot be used to apply more than a few layers of laminates before they must be discarded and replaced, thus adding unwanted solid waste. The vacuum bag of the present invention may be used repeatedly, thereby saving the time and effort to making new bags and avoiding the created of excess waste.

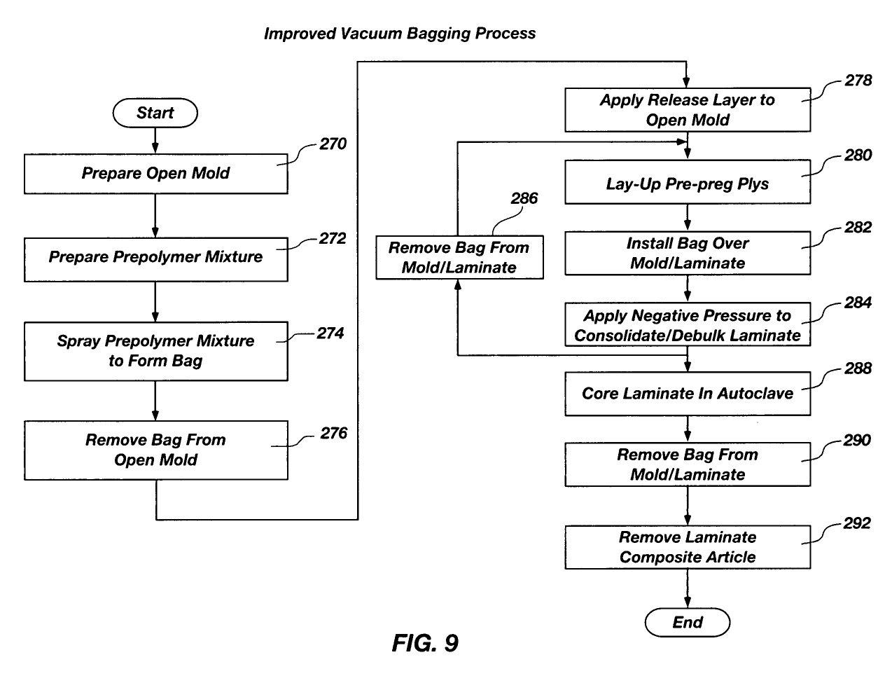

FIG. 9 illustrates a flow chart depicting an exemplary method for forming a composite part from a vacuum bagging process utilizing a reusable vacuum bag formed in accordance with the present invention. As shown, the method comprises step 270, preparing an open mold to receive the prepolymer mixture, which optionally may include, and is not limited to, applying a release layer to facilitate removal of the vacuum bag after polymerization, setting or positioning one or more spacer components, positioning one or more vacuum suction ports, etc; step 272, preparing a prepolymer mixture, such as mixing an isocyanate component with a resin blend component, respectively; step 274, forming the bag by applying the prepolymer mixture to the prepared surface of the open mold and allowing the mixture to polymerize to form a vacuum bag having a surface shape that corresponds to that of the open mold and any components positioned thereon; and step 276, removing the formed vacuum bag from the open mold.

The method continues with step 278, applying a release layer to the open mold; step 280, laying up at least one layer of pre-preg plies onto the contoured surface of the open mold to form a laminate portion, which step may include, and is not limited to applying an optional peel-ply layer, an optional release film layer, or an optional breather layer of the top of the laminate portion; step 282, installing a bag previously formed using steps 270 through 276 over the open mold and fiber preform, sealing the bag around the periphery of the open mold to form an airtight envelope, and placing the sealed volume in fluid communication with a vacuum source by connecting the vacuum suction ports to the vacuum source; step 284, drawing a negative pressure to consolidate the laminate portion by removing entrapped air or gases from the pre-peg ply's; step 286, optionally removing the bag from the open mold and laminate portion and reusing it again in step 282 as needed while repeating steps 280 through 284, until the laminate portion has been built up to its desired shape and dimensions; step 288, curing the complete laminate build-up either at ambient conditions or an elevated temperature by placing the laminate build-up and surrounding vacuum bag in an autoclave; 290 removing the bag from the mold and finished laminate composite article and reusing it again in step 282 as needed with a new laminate build-up; and step 192, removing the finished laminate composite article from the open mold.

In short, the present invention overcomes many problems associated with conventional vacuum bags used in the manufacture of composite articles by providing a method for creating a vacuum bag which can be quickly and inexpensively fabricated to fit the custom contours of an open mold, and yet is sufficiently robust and durable to be reused many times. Moreover, the reusable vacuum bag meets or surpasses current regulatory requirements in providing a sealing barrier to prevent the inadvertent release of hazardous air pollutants created in the composite manufacturing process into the surrounding environment.

The method of the present invention offers further advantages over the prior art in that it greatly speeds the process of assembling a new bag, including the integration of resin injection ports, vacuum suction ports, reinforcements, and flow channels within the structure of the bag itself. The method is highly adaptable and can be applied to open molds having a wide variety of sizes and shapes, from the large molds used in resin infusion processes to the much smaller molds used in traditional vacuum bagging processes. Moreover, the method naturally eliminates problems related to folds and wrinkles in the bag film, greatly improving the surface finish of the completed part and reducing the probability of leaks forming at seams in the bag film. And finally, the method provides for a vacuum bag that reduces the amount of solid waste generated during the manufacture of composite components by eliminating the need to throw away used bags each time a composite part is formed.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. The structure, material or acts that support the means-plus function are expressly recited in the description herein. Accordingly, the scope of the invention should be determined solely by the appended claims and their legal equivalents, rather than by the descriptions and examples given above.

What is claimed and desired to be secured by Letters Patent is:

1. A method for forming a reusable vacuum bag for use in the manufacture of a composite part, said method comprising:
applying a prepolymer mixture configured for rapid polymerization at ambient conditions over a surface having a configuration corresponding to said composite part;
rapidly polymerizing said prepolymer mixture to form a vacuum bag having a periphery and a shape substantially conforming to said surface; and
removing said vacuum bag from said surface.

2. The method of claim 1, wherein said prepolymer mixture is a polyurea-based resin made from mixing an isocyanate component and a resin blend component.

3. The method of claim 2, wherein said isocyanate component further comprises an isocyanate building block connected to a flexible link with a urethane bond

4. The method of claim 3, wherein said isocyanate building block is an MDI monomer.

5. The method of claim 3, wherein said flexible link is selected from a group consisting of polyether, silicone, and polybutadiene.

6. The method of claim 2, wherein said resin blend component further comprises an amine-terminated polymer resin.

7. The method of claim 1, further comprising positioning at least one vacuum suction port on said surface prior to said applying said prepolymer mixture.

8. The method of claim 1, further comprising positioning at least one resin injection port on said surface prior to said applying said prepolymer mixture.

9. The method of claim 1, further comprising:
positioning a spacer part on said surface prior to applying said prepolymer material, wherein said surface comprises an open mold, and wherein said spacer part comprises an upper surface that corresponds to an upper surface of a finished composite part, and a lower surface that corresponds to said open mold, said spacer part thus comprising substantially a same thickness, dimension, and configuration as said finished composite part; and
applying said prepolymer mixture over said upper surface of said spacer to form said vacuum bag having a contour that conforms substantially to said upper surface of said finished part, said vacuum bag being scaled in size as compared with said open mold.

10. The method of claim 1, further comprising:
positioning a spacer on said surface prior to said applying said prepolymer mixture, wherein said surface comprises an open mold, and wherein said spacer forms at least one flow channel in said inner surface of said vacuum bag; and
applying said prepolymer mixture over said spacer to form said vacuum bag.

11. The method of claim 1, further comprising:
applying a release layer over said surface prior to applying said prepolymer mixture;
applying a first layer of said prepolymer mixture over said release layer;
positioning a reinforcement material over said first layer of prepolymer mixture, wherein said reinforcement material is used to structurally reinforce selected selections of said reusable vacuum bag; and
applying a second layer of said prepolymer mixture over said reinforcement material, said first and second layers of said prepolymer mixture and said reinforcement material forming said vacuum bag.

12. The method of claim 2, wherein said step of mixing said isocyanate component with said resin blend component to obtain said prepolymer mixture further comprises mixing a fluid stream of said isocyanate component with a fluid stream of said resin blend component in a nozzle of a mixing gun, wherein said step of applying comprises spraying said prepolymer mixture onto said surface.

13. The method of claim 2, further comprising mixing said isocyanate component with a fluid stream of said resin blend component in a nozzle of a mixing gun at a high temperature and a high pressure.

14. A method for making a reusable vacuum bag for use in a resin infusion process for the manufacture of a composite part, said method comprising:
obtaining an isocyanate component comprising an isocyanate building block connected to a flexible link with a urethane bond;
obtaining a resin blend component comprising an amine-terminated polymer resin;
mixing said isocyanate component with said resin blend component to obtain a polyurea prepolymer mixture, said polyurea prepolymer mixture being configured for rapid polymerization at ambient conditions;
applying said polyurea prepolymer mixture in liquid form over a surface;
rapidly polymerizing said polyurea prepolymer mixture to form a reusable vacuum bag having a periphery and a shape substantially conforming to said surface; and
removing said vacuum bag from said surface.

15. The method of claim 14, wherein said isocyanate building block comprises an MDI monomer.

16. The method of claim 14, wherein said flexible link is selected from the group consisting of a polyether, a silicone, and a polybutadiene.

17. A method for vacuum impregnation of a reinforcing fiber material using a resin infusion process to produce a resin-fiber composite part, said method comprising:
obtaining a polyurea prepolymer mixture in liquid form;
causing said polyurea prepolymer mixture to rapidly polymerize by applying said polyurea prepolymer mixture over a surface to form a reusable vacuum bag having a periphery and a structure substantially conforming to said surface;
removing said vacuum bag from said surface;
positioning at least one layer of a reinforcing fiber material onto an open mold;
positioning said vacuum bag over said at least one layer of reinforcing fiber material and sealing said periphery to form an airtight chamber encapsulating said reinforcing fiber material between said open mold and said vacuum bag;
injecting a resin into said airtight chamber; and
applying vacuum pressure to said airtight chamber to draw resin through said reinforcing fiber material.

18. The method of claim 17, further comprising applying a breather layer operable with said vacuum bag.

19. The method of claim 17, wherein said step of applying a layer of polyurea prepolymer mixture in liquid form further comprises spraying said polyurea prepolymer mixture from a mixing gun.

20. A method for vacuum impregnation of a reinforcing fiber material using a vacuum bagging process to produce composite part, said comprising:
obtaining a polyurea prepolymer mixture in liquid form;
causing said polyurea prepolymer mixture to rapidly polymerize by applying said polyurea prepolymer mixture to a surface at ambient conditions to form a reusable vacuum bag having a periphery and a structure substantially conforming to said surface;
removing said vacuum bag from said surface;
positioning at least one layer of fiber reinforcement pre-pregs onto an open mold;
positioning said vacuum bag over said at least one layer of fiber reinforcement pre-pregs and sealing said periphery to form an airtight chamber encapsulating said fiber reinforcement pre-pregs between said open mold and said vacuum bag; and
applying vacuum pressure to said airtight chamber to withdraw excess air and excess resin from said fiber reinforcement pre-pregs.

21. The method of claim 20, further comprising applying a breather layer operable with said vacuum bag.

22. The method of claim 20, wherein said applying a layer of polyurea prepolymer mixture in liquid form further comprises spraying said polyurea prepolymer mixture from a mixing gun.

23. The method of claim 20, further comprising:
removing said vacuum bag upon formation of said composite part; and
repeating each of said steps of positioning at least one layer of fiber reinforcement pre-pregs onto an open mold, positioning said vacuum bag over, and applying to form another composite part utilizing said reusable vacuum bag.

24. A reusable vacuum bag for use with a composite mold to manufacture a composite part having an upper surface and a lower surface, comprising:
a layer of polyurea-based polymer having an inner surface, an outer surface, and a periphery,
wherein said inner surface is formed to substantially conform to said upper surface of said composite part, and
wherein said periphery extends beyond said edges of said composite part to seal said vacuum bag to said open mold.
